(19) United States
(12) Patent Application Publication
(10) Pub. No.: US 2026/0240068 A1
(43) Pub. Date: Aug. 20, 2026

(54) SEED DIBBER

(71) Applicant: SHANGHAI HUIXUAN INTERNATIONAL TRADE CO., LTD., SHANGHAI (CN)

(72) Inventor: TUNHUI HONG, SHANGHAI (CN)

(21) Appl. No.: 19/053,929

(22) Filed: Feb. 14, 2025

(51) Int. Cl. A01C 7/00

(52) U.S. Cl. CPC A01C 7/002

(57) ABSTRACT

A seed dibber is provided, including a handle and at least one dibber tube. The handle includes mounting positions disposed along a height direction thereof. The at least one dibber tube is mounted at any one of the mounting positions disposed along the height direction of the handle for dibbling holes at different depths. The seed dibber is capable of dibbling the holes at different depths to satisfy varying planting depth requirements of different seeds.

### TECHNICAL FIELD

The present disclosure relates to the field of agricultural planting tools, and in particular to a seed dibber.

### BACKGROUND

In the prior art, dibbling constitutes one of critical steps in agricultural production to ensure proper crop growth. To promote optimal seed germination and growth, it is essential to dibble holes in the soil at depths precisely adjusted based on specific requirements of different plant species and planting conditions. However, most of current seed dibbers are limited to a fixed dibbling depth, unable to accommodate varying depth requirements of different seeds. As a result, farmers often need to prepare multiple seed dibbers, each designed for specific depths of seeds, which increases costs.

### SUMMARY

Embodiments of the present disclosure provide a seed dibber that is capable of dibbling holes at different depths to satisfy varying planting depth requirements of different seeds.

The embodiments of the present disclosure provide the seed dibber, including a handle and at least one dibber tube. The handle includes mounting positions disposed along a height direction thereof. The at least one dibber tube is mounted at any one of the mounting positions disposed along the height direction of the handle for dibbling the holes at different depths.

Furthermore, the handle includes a plurality of groups of the mounting positions, the plurality of the groups of the mounting positions are disposed along a length direction of the handle. Each of the plurality of the groups of the mounting positions is configured to mount one of the at least one dibber tube, the at least one dibber tube is mounted at at least one of the plurality of the groups of the mounting positions.

Furthermore, the at least one dibber tube is detachably mounted to the handle.

Furthermore, each of the mounting positions includes a first mounting hole defined on the handle, and the at least one dibber tube defines a second mounting hole. The seed dibber further includes at least one mounting component, the at least one mounting component passes through a corresponding first mounting hole and the second mounting hole and is configured to connect the at least one dibber tube and the handle.

Furthermore, an internal thread is disposed in the second mounting hole, an external thread is disposed on a periphery of the at least one mounting component, and the at least one mounting component is threadedly connected to the internal thread of the second mounting hole through the external thread thereof for connecting the at least one dibber tube and the handle.

Furthermore, the at least one dibber tube includes an inserting portion and two first connecting portions, the inserting portion and the handle are sequentially disposed in the height direction of the handle, the two first connecting portions are connected to one side of the inserting portion facing the handle, the two first connecting portions are spaced apart from each other and form connecting grooves with the inserting portion. The handle is disposed in the connecting grooves and is connected to the two first connecting portions.

Furthermore, a first one of the two first connecting portion defines the second mounting hole, a second one of the two first connecting portion defines a third mounting hole, the at least one mounting component sequentially passes through the third mounting hole, the corresponding first mounting hole, and the second mounting hole, and the at least one mounting component is threadedly connected and fixed to the second mounting hole.

Furthermore, the handle includes a base plate and limiting portions, each first mounting hole is defined on the base plate, the base plate includes a first side and a second side, the first side of the base plate is disposed opposite to the second side of the base plate, and each first mounting hole penetrates through the first side of the base plate and the second side of the base plate. The limiting portions are disposed on at least one of the first side of the base plate and the second side of the base plate, each two of limiting portions are respectively disposed at two sides of a corresponding first mounting hole along the length direction of the handle, and the two first connecting portions are at least partially disposed between corresponding two of the limiting portions.

Furthermore, each of the limiting portions includes a first inclined surface at one side thereof facing the inserting portion. Each of the two first connecting portions includes a middle block and a clamping block, each middle block is connected to the inserting portion, each clamping block is connected to one side of a corresponding middle block facing away from the inserting portion, and each clamping block is configured to be disposed between corresponding two of the limiting portions. Along the length direction of the handle, a width of each middle block is greater than a width of a corresponding clamping block, the one side of each middle block facing away from the inserting portion includes a second inclined surface, each second inclined surface is matched with a corresponding first inclined surface.

Furthermore, the at least one mounting component includes a rod portion and a head portion, and the rod portion passes through the base plate and the two first connecting portion. Along the length direction of the handle, a width of the head portion is greater than a distance between corresponding two of the limiting portions.

Furthermore, the handle further includes at least one limiting protrusion, the at least one limiting protrusion is disposed on at least one of the first side of the base plate and the second side of the base plate, along the height direction of the handle, the at least one limiting protrusion is disposed at one side of a corresponding first mounting hole facing the inserting portion. At least one of the two first connecting portions defines a limiting groove corresponding to the at least one limiting protrusion, the at least one limiting protrusion is disposed in the limiting groove of the at least one of the two first connecting portions.

Furthermore, the inserting portion is symmetrically disposed along a center line of the two first connecting portions.

Furthermore, the inserting portion includes an inserting end, the inserting end is distal to the handle, a distance between the inserting end and the handle is inversely related to a cross-sectional area of the inserting end.

Furthermore, the inserting end is conical.

Furthermore, a plurality of dibber tubes are provided, and the plurality of the dibber tubes are uniformly mounted to the handle.

Furthermore, markings are disposed on the handle, and the markings are configured to guide the plurality of the dibber tubes with different quantities to be uniformly mounted on the handle.

Furthermore, the markings are grouped and evenly spaced along the handle, different groups of the markings are labeled with different numerals, and the different numerals are configured to guide corresponding quantities of the plurality of the dibber tubes to be uniformly mounted on the handle.

Furthermore, the handle includes a base plate and a grip, the at least one dibber tube is mounted to a first side of the base plate, the grip protrudes from a second side of the base plate for a human hand to hold.

Furthermore, the grip includes a holding portion and two second connecting portions, the holding portion is spaced apart from the base plate, two ends of the holding portion are connected to the base plate respectively through the two second connecting portions.

Furthermore, the holding portion includes a hollow tubular body, two ends of the hollow tubular body are connected to the base plate respectively through the two second connecting portions, and an outer surface of the hollow tubular body is an arc surface.

According to the embodiments of the present disclosure, the seed dibber includes the handle and the at least one dibber tube, the at least one dibber tube is mounted at any one of the mounting positions disposed along the height direction of the handle. Since the mounting positions are arranged along the height direction of the handle, by changing a position of the at least one dibber tube on the handle, a distance between the at least one dibber tube and the ground is adjusted, so as to dibble the holes at different depths. Specifically, when the at least one dibber tube is mounted at a higher position on the handle, at least one shallower hole is dibbled; whereas when the at least one dibber tube is mounted at a lower position on the handle, at least one deeper hole is dibbled. Therefore, users only need to select an appropriate mounting position for the at least one dibber tube based on their planting requirements to easily dibble the holes at different depths, the planting depth requirements of different seeds are satisfied without needing to switch to different seed dibbers, which is convenient in operation, thereby improving planting efficiency further enhancing versatility and practicality of the seed dibber.

### BRIEF DESCRIPTION OF DRAWINGS

In order to more clearly illustrate technical solutions in the embodiments of the present disclosure, the following briefly describes accompanying drawings required in description of the embodiments of the present disclosure. Obviously, the accompanying drawings in the following description are merely some embodiments of the present disclosure, and for those who skilled in the art, other drawings may be obtained based on the accompanying drawings without creative efforts.

For a more complete understanding of the present disclosure and its beneficial effects, the following description is made with reference to the accompanying drawings, in which identical reference numerals denote identical parts.

FIG. 1 is a structural schematic diagram of a seed dibber according to one embodiment of the present disclosure.

FIG. 2 is a structural schematic diagram of a handle of the seed dibber shown in FIG. 1.

FIG. 3 is another structural schematic diagram of the handle shown in FIG. 2.

FIG. 4 is an enlarged schematic diagram of portion B of the handle shown in FIG. 3.

FIG. 5 is structural schematic diagram of a dibber tube of the seed dibber shown in FIG. 1.

FIG. 6 is another structural schematic diagram of the seed dibber according to one embodiment of the present disclosure.

FIG. 7 is a cross-sectional schematic diagram of the seed dibber, taken along the line A-A shown in FIG. 6.

Reference numerals in the drawings: 1. seed dibber; 10. handle; 11. mounting position; 111. first mounting hole; 12. base plate; 122. first side; 14. limiting portion; 142. first inclined surface; 16. limiting protrusion; 17. marking; 18. grip; 182. holding portion; 184. second connecting portion; 20. dibber tube; 21. second mounting hole; 22. inserting portion; 222. inserting end; 23. third mounting hole; 24. first connecting portion; 242. middle block; 2422. second inclined surface; 244. clamping block; 245. limiting groove; 25. connecting groove; 30. mounting component; 32. rod portion; 34. head portion.

### DETAILED DESCRIPTION OF EMBODIMENTS

The following clearly and completely describes technical solutions in embodiments of the present disclosure with reference to accompanying drawings in the embodiments of the present disclosure. Obviously, described embodiments are only a part but not all of the embodiments of the present disclosure. Description of at least one exemplary embodiment in the following is merely illustrative and should not be construed as any limitation on the present disclosure or its applications or uses. All other embodiments obtained by those who skilled in the art based on the embodiments of the present disclosure without creative efforts shall fall within a protection scope of the present disclosure.

Reference herein to “embodiment” means that a particular feature, structure, or characteristic described in connection with the embodiment may be included in at least one embodiment of the present disclosure. The appearances of this phrase in various places in the specification are not necessarily all referring to the same embodiment, nor are separate or alternative embodiments mutually exclusive with other embodiments. It is explicitly and implicitly understood by those who skilled in the art that the embodiments described herein may be combined with other embodiments.

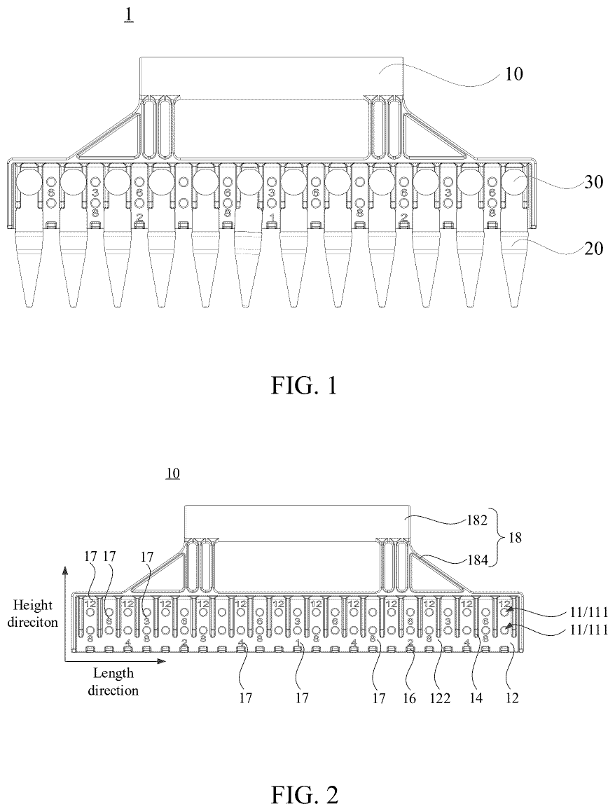

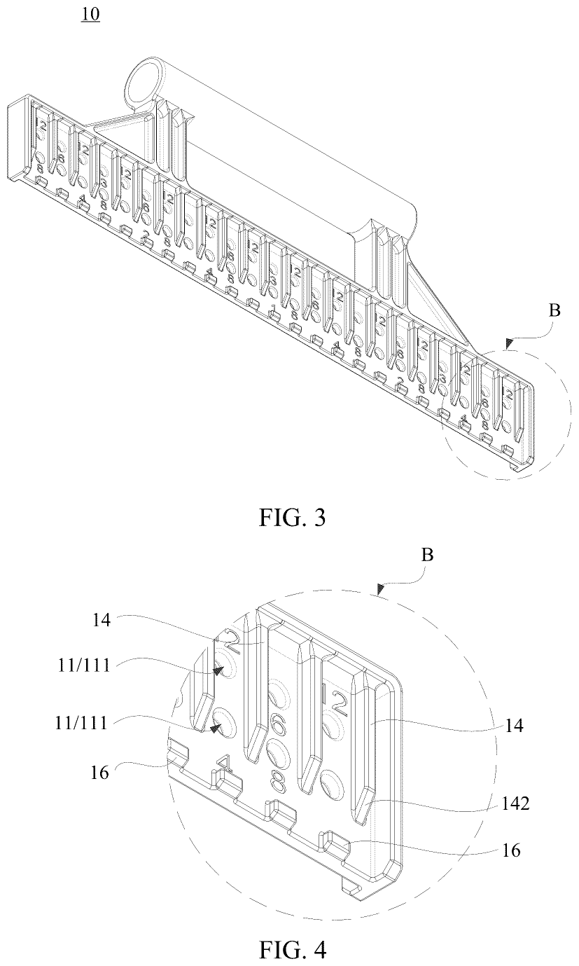

Please refer to FIGS. 1-3, FIG. 1 is a structural schematic diagram of a seed dibber according to one embodiment of the present disclosure, FIG. 2 is a structural schematic diagram of a handle of the seed dibber shown in FIG. 1, FIG. 3 is another structural schematic diagram of the handle shown in FIG. 2, and FIG. 4 is an enlarged schematic diagram of portion B of the handle shown in FIG. 3. The embodiments of the present disclosure provide the seed dibber 1, including a handle 10 and at least one dibber tube 20. The handle 10 is provided for users to hold and operate the seed dibber 1. The handle 10 includes mounting positions 11 disposed along a height direction thereof. The mounting positions 11 are configured to fix and mount the at least one dibber tube 20.

The at least one dibber tube 20 is configured to dibble holes in the soil. The at least one dibber tube 20 is mounted at any one of the mounting positions 11 disposed along the height direction of the handle 10. Since the mounting positions 11 are arranged along the height direction of the handle 10, by changing a position of the at least one dibber tube 20 on the handle 10, a distance between the at least one dibber tube 20 and the ground is adjusted, so as to dibble the holes at different depths. Specifically, when the at least one dibber tube 20 is mounted at a higher position on the handle 10, at least one shallower hole is dibbled; whereas when the at least one dibber tube 20 is mounted at a lower position on the handle 10, at least one deeper hole is dibbled. According to the present disclosure, the users only need to select an appropriate mounting position for the at least one dibber tube 20 based on their planting requirements to easily dibble the holes at different depths, planting depth requirements of different seeds are satisfied without needing to switch to different seed dibbers, which is convenient in operation, thereby improving planting efficiency further enhancing versatility and practicality of the seed dibber 1.

In some embodiments, the handle 10 includes a plurality of groups of the mounting positions 11, the plurality of the groups of the mounting positions 11 are disposed along a length direction of the handle 10. Each of the plurality of the groups of the mounting positions 11 is configured to mount one of the at least one dibber tube 20, the at least one dibber tube 20 is mounted at at least one of the plurality of the groups of the mounting positions 11.

The plurality of the groups of the mounting positions 11 are disposed along the length direction of the handle 10, and corresponding mounting positions 11 in each of the plurality of the groups of the mounting positions 11 are disposed along the height direction of the handle 10, when a plurality of dibber tubes 20 are provided, the plurality of the dibber tubes 20 are mounted to the handle 10 in a form similar to a two-dimensional matrix, so that a mounting depth of the at least one dibber tube 20 is adjusted through the corresponding mounting positions 11 in each of the plurality of the groups of the mounting positions 11 in the height direction of the handle 10 to adapt to the planting depth requirements of different seeds, and the plurality of the groups of the mounting positions 11 disposed along the length direction of the handle 10 are provided to mount different quantities of the plurality of the dibber tubes 20 according to planting scale and efficiency requirements, so as to achieve single-head dibbling or multi-head dibbling. Specifically, such multi-head dibbling design allows for completing multiple dibbling tasks in a single operation, which significantly improves planting efficiency. This is especially suitable for large-scale planting operations or scenarios requiring rapid seeding. Therefore, the seed dibber 1 of the present disclosure is capable of adapting to various planting conditions and requirements, whether for single-depth and single-quantity seeding, or multi-depth and multi-quantity seeding, the seed dibber 1 of the present disclosure may easily handle all scenarios, thereby offering strong versatility and adaptability.

In some embodiments, the at least one dibber tube 20 is detachably mounted to the handle 10.

In the embodiments, the at least one dibber tube 20 is detachably mounted to the handle 10, so that mounting and removing the at least one dibber tube 20 become simple and quick. The users may complete mounting or removing of the at least one dibber tube in a short time without complex tools or cumbersome operational steps, thereby improving work efficiency. When the seed dibber 1 is not in use, the at least one dibber tube 20 is removed detached from the handle 10, so as to significantly reduce an overall size of the seed dibber 1 for easier storage and transportation. The users may easily store the seed dibber 1 in a toolbox, warehouse corner, or vehicle trunk without occupying much space. When the seed dibber 1 is required to use, the seed dibber 1 is enabled to be quickly assembled, which allows the users to conveniently perform planting tasks anytime and anywhere, so as to enhance portability and practicality of the seed dibber 1.

During actual use, detachable installation design of the at least one dibber tube 20 provides great convenience for the users. The users may flexibly adjust a quantity and a layout of the at least one dibber tube 20 according to different seed types and planting requirements. Specifically, the at least one dibber tube 20 is accurately mounted along the mounting positions 11 in the height direction and the plurality of the groups of the mounting positions 11 in the length direction of the handle 10 to ensure that each dibber tube 20 accurately dibbles the holes to a predetermined depth and position, thereby improving planting precision. In the embodiments of the seed dibber 1, through detachably mounting the plurality of the dibber tubes 20 to the handle 10, flexible switching of various planting modes is achieved, thereby avoiding necessity of purchasing a plurality of conventional seed dibbers with fixed configurations by the users due to different planting requirements, so as to effectively reduce both quantity and cost of device purchases. Moreover, the users may reasonably configure the quantity of the at least one dibber tube 20 according to an actual planting scale and budget, thereby avoiding unnecessary waste. In addition, after a seeding task is completed, the users may easily remove the at least one dibble tube 20 and properly store for the next use, which prolongs a service life of the seed dibber 1 and further provides an efficient, economical, and practical planting solution for the users.

In some embodiments, each dibber tube 20 is slidably mounted to the handle 10, which also provides convenience for the users to operate, for example, each dibber tube 20 is slidably mounted along the height direction of the handle 10, and the users slide each dibber tube 20 to adjust a specific position thereof according to different seed types and planting requirements, so as to dibble the holes at different depths. Such sliding installation mechanism enables the users to quickly and conveniently adjust a seeding depth without removing the at least one dibber tube 20, and also reduces a risk of device wear and damage caused by frequent disassembly and assembly.

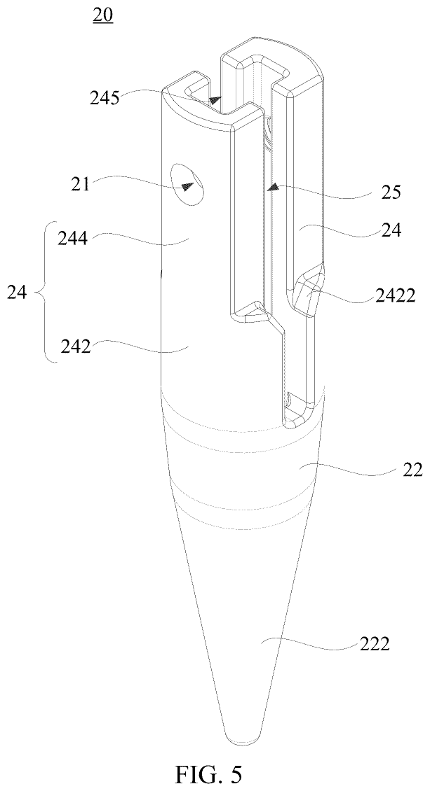

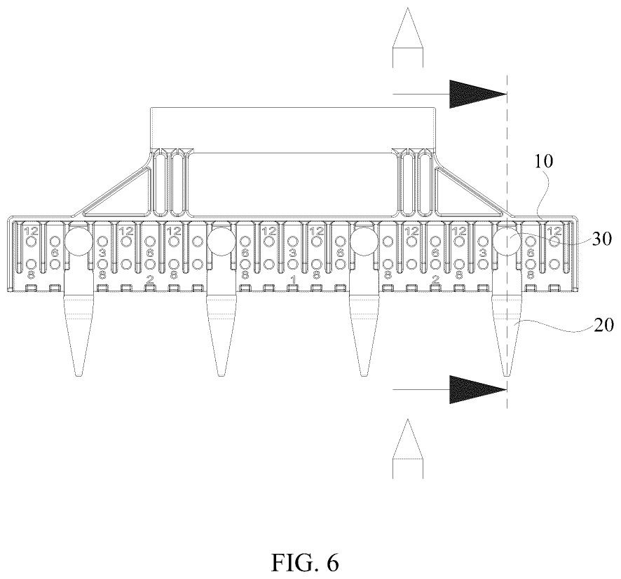

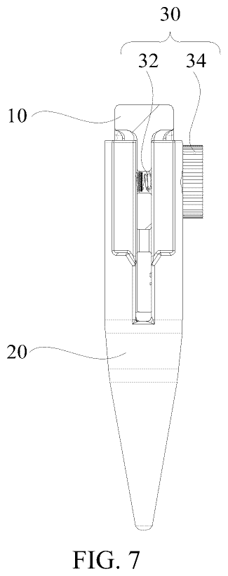

Please further refer to FIGS. 5-7, FIG. 5 is structural schematic diagram of a dibber tube of the seed dibber shown in FIG. 1, FIG. 6 is another structural schematic diagram of the seed dibber according to one embodiment of the present disclosure, and FIG. 7 is a cross-sectional schematic diagram of the seed dibber, taken along the line A-A shown in FIG. 6. In some embodiments, each of the mounting positions 11 includes a first mounting hole 111 defined on the handle 10, and the at least one dibber tube 20 defines a second mounting hole 21. The seed dibber 1 further includes at least one mounting component 30, the at least one mounting component 30 passes through a corresponding first mounting hole 111 and the second mounting hole 21 and is configured to connect the at least one dibber tube 20 and the handle 10.

According to the seed dibber 1 of the embodiments, the mounting positions 11 are disposed on the handle 10, each of the mounting positions 11 includes the first mounting hole 111 defined on the handle 10, correspondingly, the at least one dibber tube 20 defines the second mounting hole 21. In order to connect the at least one dibber tube 20 and the handle 10, the seed dibber 1 further includes the at least one mounting component 30, the at least one mounting component 30 passes through the corresponding first mounting hole 111 on the handle 10 and the second mounting hole 21 on the at least one dibber tube 20 to fixedly connect the at least one dibber tube 20 to the handle 10. Through cooperation between the at least one mounting component 30 and corresponding mounting holes, the at least one dibble tube 20 is flexibly and detachably connected to the handle 10, which is convenient for the users to quickly adjust the quantity and the layout of the at least one dibber tube 20 according to different planting requirements.

In addition to using the at least one mounting component 30 and the mounting holes, other manners, such as clamping, are also capable of connecting the at least one dibber tube 20 to the handle 10. By respectively providing corresponding clamping grooves and buckles on the handle 10 and the at least one dibber tube 20, the at least one dibber tube 20 is quickly clamped into a corresponding one of the mounting positions 11 of the handle 10 without additional mounting component 30, which further simplifies mounting and removing processes of the at least one dibber tube 20.

In some embodiments, an internal thread is disposed in the second mounting hole 21, an external thread is disposed on a periphery of the at least one mounting component 30, and the at least one mounting component 30 is threadedly connected to the internal thread of the second mounting hole 21 through the external thread thereof for connecting the at least one dibber tube 20 and the handle 10.

In the embodiments, the internal thread is disposed in the second mounting hole 21, and the external thread matching with the internal thread is disposed on the periphery of the at least one mounting component 30. Through such threaded connection manner, the at least one mounting component 30 is firmly screwed with the second mounting hole 21, thereby firmly connecting the at least one dibber tube 20 to the handle 10. In this way, not only a connection is stable, but also an operation is convenient and fast, and the users may easily mount and remove the at least one dibber tube 20 by rotating the at least one mounting component 30.

Moreover, in addition to directly connecting the at least one dibber tube 20 to the handle 10 through threads, stability of the connection is also enhanced by combining a nut with the at least one mounting component 30. In this design, after a first end of the at least one mounting component 30 passes through a corresponding first mounting hole 111 of the handle 10 and the second mounting hole 21 of the at least one dibber tube 20 and is fastened at a second end of the at least one mounting component 30 through the nut. Through cooperation between the nut and the at least one mounting component 30, stability and reliability of the at least one dibber tube 20 during use is ensured.

In some embodiments, the at least one dibber tube 20 includes an inserting portion 22 and two first connecting portions 24, the inserting portion 22 and the handle 10 are sequentially disposed in the height direction of the handle 10, the two first connecting portions 24 are connected to one side of the inserting portion 22 facing the handle 10, the two first connecting portions 24 are spaced apart from each other and form connecting grooves 25 with the inserting portion 22. The handle 10 is disposed in the connecting grooves 25 and is connected to the two first connecting portions 24.

In the embodiments, the at least one dibber tube 20 includes the inserting portion 22 and the two first connecting portions 24. The inserting portion 22 serves as a critical component of the at least one dibber tube 20 for soil contact and hole dibbling. The two first connecting portions 24 are disposed on the one side of the inserting portion 22 facing the handle 10, the two first connecting portions 24 are spaced apart from each other and form the connecting grooves 25 with the inserting portion 22. The handle 10 is disposed in the connecting grooves 25 and is connected to the two first connecting portions 24, the two first connecting portions 24 clamp the handle 10 from two opposite sides. Such clamping connection configuration provides enhanced structural stability and support, enabling effective distribution and balancing of forces exerted on the at least one dibber tube 20 during operation, which significantly reduces risks of displacement or damage to the at least one dibber tube 20 caused by external forces. Particularly during multi-head dibbling operations or when working in harder soil conditions, such clamping connection configuration ensures maintained stability of the at least one dibber tube 20, thereby improving seeding precision and operational quality.

Moreover, in some embodiments, the at least one dibber tube 20 is connected to the handle 10 only though one side, without being clamped and fixed from both sides. Such mounting manner achieve connection between the at least one dibber tube 20 and the handle 10 and is relatively simpler in structure. However, such single-side mounting method has relatively poorer stability.

In some embodiments, a first one of the two first connecting portion 24 defines the second mounting hole 21, a second one of the two first connecting portion 24 defines a third mounting hole 23, the at least one mounting component 30 sequentially passes through the third mounting hole 23, the corresponding first mounting hole 111, and the second mounting hole 21, and the at least one mounting component 30 is threadedly connected and fixed to the second mounting hole 21.

In the embodiments, the at least one dibber tube 20 is connected to the handle 10 through the two first connecting portions 24, and the two first connecting portions 24 clamp the handle 10 from the two opposite sides to form a stable structure. Specifically, the first one of the two first connecting portion 24 defines the second mounting hole 21, the second one of the two first connecting portion 24 defines the third mounting hole 23, the handle 10 defines each first mounting hole 111, during a mounting process of the at least one dibber tube 20, the two first connecting portions 24 of the at least one dibber tube 20 are first aligned with the handle 10 to ensure that the third mounting hole 23, the corresponding first mounting hole 111, and the second mounting hole 21 are on the same straight line. Then, the at least one mounting component 30, such as a bolt, sequentially passes through the third mounting hole 23, the corresponding first mounting hole 111, and the second mounting hole 21. The external thread matching with the internal thread of the second mounting hole 21 is disposed on the periphery of the at least one mounting component 30. By rotating the mounting component 30, the external thread of the at least one mounting component 30 are threadedly connected and fixed with the internal thread of the second mounting hole 21, so that the two first connecting portions 24 of the at least one dibber tube 20 are firmly connected to the handle 10. Such connection manner enables the two first connecting portions 24 to clamp the handle 10 from the two opposite sides, provides additional support, ensures that the at least one dibber tube 20 does not shift or shake during use, and is convenient for the users to remove and maintain the at least one dibber tube 20.

In some embodiments, the handle 10 includes a base plate 12 and limiting portions 14, each first mounting hole 111 is defined on the base plate 12, the base plate 12 includes a first side 122 and a second side, the first side 122 of the base plate 12 is disposed opposite to the second side of the base plate 12, and each first mounting hole 111 penetrates through the first side 122 of the base plate 12 and the second side of the base plate 12. The limiting portions 14 are disposed on at least one of the first side 122 of the base plate 12 and the second side of the base plate 12, each two of limiting portions 14 are respectively disposed at two sides of a corresponding first mounting hole 111 along the length direction of the handle 10, and the two first connecting portions 24 are at least partially disposed between corresponding two of the limiting portions 14.

According to the handle 10 of the embodiments, the base plate 12 defines each first mounting hole 111 that penetrates through the first side 122 of the base plate 12 and the second side of the base plate 12 for the at least one mounting component 30 to pass through, the limiting portions 14 are disposed on at least one of the first side 122 of the base plate 12 and the second side of the base plate 12, each two of limiting portions 14 are respectively disposed at the two sides of the corresponding first mounting hole 111 along the length direction of the handle 10. The limiting portions 14 are configured to guide mounting of the two first connecting portions 24 of the at least one dibber tube 20 and limit the two first connecting portions 24 in the length direction of the handle 10, which ensures that the two first connecting portion 24 are accurately positioned and aligned with a corresponding first mounting hole 111 during the mounting process of the at least one dibber tube 20, and are displaced in the length direction of the handle 10 after the at least one dibber tube 20 is mounted to the handle 10, thereby improving mounting accuracy and mounting stability. When mounting the at least one dibber tube 20, the users only need to insert the two first connecting portions 24 of the at least one dibber tube 20 into a space between corresponding two limiting portions 14 disposed at the two sides of a corresponding first mounting hole 111 to ensure that the two first connecting portion 24 of the at least one dibber tube 20 are aligned with the corresponding first mounting hole 111. Subsequently, the a least one mounting component 30, such as the bolt, sequentially passes through the third mounting hole 23, the corresponding first mounting hole 111, and the second mounting hole 21, and is screwed and fixed into the second mounting hole 21 or fixed through the nut to complete the connection between the at least one dibber tube 20 and the handle 10.

In some embodiments, each of the limiting portions 14 includes a first inclined surface 142 at one side thereof facing the inserting portion 22. Each of the two first connecting portions 24 includes a middle block 242 and a clamping block 244, each middle block 242 is connected to the inserting portion 22, each clamping block 244 is connected to one side of a corresponding middle block 242 facing away from the inserting portion 22, and each clamping block 244 is configured to be disposed between corresponding two of the limiting portions 14. Along the length direction of the handle 10, a width of each middle block 242 is greater than a width of a corresponding clamping block 244, the one side of each middle block 242 facing away from the inserting portion 22 includes a second inclined surface 2422, each second inclined surface 2422 is matched with a corresponding first inclined surface 142.

In the embodiments, each of the limiting portions 14 includes the first inclined surface 142 at the one side thereof facing the inserting portion 22. Each of the two first connecting portions 24 includes the middle block 242 and the clamping block 244, each middle block 242 is connected to the inserting portion 22 of the at least one dibber tube 20, the one side of each middle block 242 facing away from the inserting portion 22 includes the second inclined surface 2422, each second inclined surface 2422 is matched with the corresponding first inclined surface 142, each clamping block 244 is connected to the one side of the corresponding middle block 242 facing away from the inserting portion 22, and each clamping block 244 is configured to be disposed between the corresponding two of the limiting portions 14, which ensures that the two first connecting portions 24 are accurately guided and limited during mounting the at least one dibber tube 20. Along the length direction of the handle 10, the width of each middle block 242 is greater than the width of the corresponding clamping block 244, so that the middle block 242 provides more stable support in the mounting process of the at least one dibber tube 20, and each clamping block 244 is flexibly clamped between the corresponding limiting portions 14. When each clamping block 244 is pushed into the corresponding limiting portions 14 and reaches a certain depth for mounting to a correct position, the first inclined surface 142 of each of the corresponding limiting portion 14 and the second inclined surface 2422 of a corresponding middle block 242 abut against each other to prevent further movement of each clamping block 244. Through cooperation of the first inclined surface 142 of each of the limiting portions 14 and the second inclined surface 2422 of the corresponding middle block 242, a contact area is increased, and when the inserting portion 22 is subjected to force, a larger contact area allows for better distribution and transmission of the force, thereby improving connection strength of the two first connecting portions 24 and the handle 10 and preventing the two first connecting portions 24 from shifting or loosening in a using process, in this way, durability of the seed dibber 1 is improved.

In some embodiments, the at least one mounting component 30 includes a rod portion 32 and a head portion 34, and the rod portion 32 passes through the base plate 12 and the two first connecting portion 24. Along the length direction of the handle 10, a width of the head portion 34 is greater than a distance between corresponding two of the limiting portions 14.

In the embodiments, the rod portion 32 of the at least one mounting component 30 sequentially passes through the third mounting hole 23 on the at least one dibber tube 20, a corresponding first mounting hole 111 on the base plate 12 of the handle 10, and the second mounting hole 21 on the at least one dibber tube 20. The rod portion 32 smoothly passes through the third mounting hole 23 on the at least one dibber tube 20, a corresponding first mounting hole 111 on the base plate 12 of the handle 10, and the second mounting hole 21 on the at least one dibber tube 20, and is screwed and fixed into the second mounting hole 21 or fixed through the nut. The width of the head portion 34 of the at least one mounting component 30 is greater than the distance between the corresponding two of the limiting portions 14, and after the at least one mounting component 30 is completely mounted, the head portion 34 is not recessed between the corresponding two of the limiting portions 14, which is convenient for the users to rotate the head portion 34, and the width of the head portion 34 is relatively large, so that the users are enabled to more easily grasp the head portion 34 of the at least one mounting component 30 to rotate, in this way, quickly assembling and disassembling of the seed dibber 1 is achieved, and operation difficulty of assembly and disassembly of the seed dibber 1 is reduced.

In some embodiments, the handle 10 further includes at least one limiting protrusion 16, the at least one limiting protrusion 16 is disposed on at least one of the first side 122 of the base plate 12 and the second side of the base plate 12, along the height direction of the handle 10, the at least one limiting protrusion 16 is disposed at one side of a corresponding first mounting hole 111 facing the inserting portion 22. At least one of the two first connecting portions 24 defines a limiting groove 245 corresponding to the at least one limiting protrusion 16, the at least one limiting protrusion 16 is disposed in the limiting groove 245 of the at least one of the two first connecting portions 24.

In the embodiments, the at least one limiting protrusion 16 is disposed on the base plate 12 of the handle 10, the at least one of the two first connecting portions 24 defines the limiting groove 245 corresponding to the at least one limiting protrusion 1, and the limiting groove 245 of the at least one of the two first connecting portions 24 is matched with the at least one limiting protrusion 16 to ensure that the two first connecting portions 24 are accurately guided and fixed at a predetermined position during the mounting process of the at least one dibber tube 20, thereby preventing the two first connecting portions 24 from shifting or loosening during use, in this way, connection accuracy and connection stability are improved.

In some embodiments, the inserting portion 22 is symmetrically disposed along a center line of the two first connecting portions 24.

In the embodiments, the inserting portion 22 is disposed between the two first connecting portions 24 and is symmetrically disposed along the center line of the two first connecting portions 24.

In this embodiment, the inserting portion 22 is located between the two first connecting parts 24 and is symmetrically arranged along the middle line of the two first connecting parts 24, which not only is more easily and accurately guided and fixed at a predetermined position during the mounting process of the at least one dibber tube 20, but also provides better balance and stability during use. In this way, shaking or shifting caused by asymmetric forces are reduced, and reliability of the seed dibber 1 during use is further improved. In addition, such symmetrical arrangement further provides a simpler and more standardized manufacturing process.

In some embodiments, the inserting portion 22 includes an inserting end 222, the inserting end 222 is distal to the handle 10, a distance between the inserting end 222 and the handle 10 is inversely related to a cross-sectional area of the inserting end 222.

In other words, such design of the inserting portion 22 enables the inserting end 222, which is distal to the handle 10, to become progressively more tapered as the distance from the handle 10 increases. The sharper the inserting end 222, the greater a penetration force of the inserting end 222 into the soil, so that it is easier to dibble the holes in the soil to improve hole-dibbling efficiency.

For example, the inserting end 222 is conical. The inserting end 222 being conical has a great penetration force when being inserted into the soil, which is capable of more easily piercing a surface layer of the so to reduce a force required for insertion.

In some embodiments, a plurality of dibber tubes 20 are provided, and the plurality of the dibber tubes 20 are uniformly mounted to the handle 10.

In the embodiments, the plurality of the dibber tubes 20 are uniformly mounted to the handle 10 and are arranged along the length direction of the handle 10, and spacing between each adjacent two of the plurality of the dibber tubes 20 is fixed, so that the users may complete multi-hole dibbling at one time without measuring the spacing one by one, the spacing between each adjacent two of the plurality of the dibber tubes 20 is consistent, so that a problem of uneven hole spacing caused by manually dibbling the holes one to one is avoided, planting uniformity and planting efficiency are further improved.

Moreover, the plurality of the dibber tubes 20 are uniformly arranged along the length direction of the handle 10 to ensure linearity of dibbling, so that seeding holes, which are dibbled at the same time, are arranged on the same straight line, thereby avoiding a problem of poor straightness caused by manually dibbling the holes one to one. Therefore, the seed dibber 1 in the embodiments ensures the alignment and uniformity of planting, addressing issues found in conventional planting methods, such as uneven hole spacing and poor linearity, which lead to inconsistent plant growth. Uniform hole spacing and even alignment in a straight line facilitate better plant growth by reducing competition for sunlight and nutrients, thereby enhancing both yield and quality of plants.

In some embodiments, markings 17 are disposed on the handle 10, and the markings 17 are configured to guide the plurality of the dibber tubes 20 with different quantities to be uniformly mounted on the handle 10.

In the embodiments, to accommodate different planting requirements and facilitate uniform mounting of an appropriate quantity of the plurality of the dibber tubes 20 on the handle 10, the markings 17 are disposed on the handle 10. The users may quickly determine recommended positions for each of the plurality of the dibber tubes 20 according to the markings 17, thereby enabling precise control over spacing between the plurality of the dibber tubes 20. For example, the markings 17 are selected from forms of numerals, colors, patterns, text, labels, etc., specific forms of the markings 17 are not limited herein.

In some embodiments, the markings 17 are grouped and evenly spaced along the handle 10, different groups of the markings 17 are labeled with different numerals, and the different numerals are configured to guide corresponding quantities of the plurality of the dibber tubes 20 to be uniformly mounted on the handle 10.

In the embodiments, the markings 17 on the handle 10 are grouped, the different groups of the markings 17 are labeled with the different numerals, the different numerals represent the recommended positions for each of the plurality of the dibber tubes 20. For example, the handle 10 is engraved with seven groups of markings 17, in which a first group is labeled with “1”, a second group is labeled with “2”, a third group is labeled with “3”, a fourth group is labeled with “4”, a fifth group is labeled with “6”, a sixth group is labeled with “8”, and a seventh group is labeled with “12”. If plants being grown require smaller spacing between them, the users may provide a greater quantity of the plurality of the dibber tubes 20 on the handle 10, such as eight or twelve dibber tubes 20. At this time, the users position the eight or twelve dibber tubes 20 at locations indicated by the markings 17 labeled with “8” or “12”. Conversely, if the plants being grown require larger spacing, the users may provide a smaller quantity of the plurality of the dibber tubes 20 on the handle 10, such as two or four dibber tubes 20, and the two or four dibber tubes 20 are positioned at locations indicated by the markings 17 labeled with “2” or “4”. In the embodiments, the different groups of the markings 17 are all meticulously arranged to ensure that corresponding quantities of the plurality of the dibber tubes 20 are evenly distributed along the handle 10 after mounting the corresponding quantities of the plurality of the dibber tubes 20 according to the markings 17. Such design ensures that spacing between holes dibbled by the corresponding quantities of the plurality of the dibber tubes 20 remains consistent, and there is no need for the users to perform any complex calculations or measurements. By simply referring to markings 17 on the handle 10, the users may quickly and accurately determine correct positions for mounting the corresponding quantities of the plurality of the dibber tubes 20, which significantly enhances efficiency of mounting the plurality of the dibber tubes 20, thereby improving both usability and flexibility of the seed dibber 1.

It should be noted that, during actual use, the users may mount the plurality of the dibber tubes 20 at positions recommended by the markings 17 on the handle 10 and may also flexibly adjust positions of the plurality of the dibber tubes 20 on the handle 10 based on specific planting requirements. In this way, the seed dibber 1 is better adapted to various planting scenarios and individual requirements, thereby further enhancing the practicality and the adaptability of the seed dibber 1.

In some embodiments, the handle 10 includes a base plate 12 and a grip 18, the at least one dibber tube 20 is mounted to one side of the base plate 12, the grip 18 protrudes from another side of the base plate 12 for a human hand to hold.

In the embodiments, the mounting positions 11 are disposed at the one side of the base plate 12 for fixing the different quantities of the plurality of the dibber tubes 20, the grip 18 protrudes from another side of the base plate 12 for the human hand to hold, which allows the users to better apply force when dibbling the holes using the seed dibber 1, and the users are also allowed to hold the handle 18 with one hand to operate the seed dibber 1, so as to improve convenience of operation.

In some embodiments, the grip 18 includes a holding portion 182 and two second connecting portions 184, the holding portion 182 is spaced apart from the base plate 12, two ends of the holding portion 182 are connected to the base plate 12 respectively through the two connecting portions.

In the embodiments, the handle 18 includes the holding portion 182 and the two second connecting portions 184, and the holding portion 182 is configured to directly hold by the users. Two ends of the holding portion 182 are connected to the base plate 12 respectively through the two connecting portions, such that there is a certain space between the holding portion 182 and the base plate 12, a sufficient grip area for hands of the users is provided, which is convenient to comfortably and firmly hold by the users. Specifically, the holding portion 182 and the two second connecting portions 184 are integrally formed, or are connected by welding, threaded connection, or other mechanical fixing manners to ensure structural stability of the handle 10, thereby reducing shaking and instability during use. In addition, a shape and a size of the holding portion 182 is designed according to ergonomic principles to provide a comfortable holding experience and enhanced control.

In some embodiments, the holding portion 182 includes a hollow tubular body, two ends of the hollow tubular body are connected to the base plate 12 respectively through the two connecting portions, and an outer surface of the hollow tubular body is an arc surface.

In the embodiments, the holding portion 182 is a hollow tubular body, which reduces an overall weight thereof and improves comfort of user holding. The outer surface of the hollow tubular body is the arc surface, which is capable of fit curves of palms of the users, so as to reduce fatigue due to prolonged use. Moreover, the hollow tubular body and the arc outer surface thereof further improves aesthetics, thereby providing users with a more comfortable and convenient user experience.

In the foregoing embodiment, description of each embodiment has its own emphasis, and parts that are not described in detail in an embodiment may refer to related descriptions of other embodiments. The embodiments, implementations, and related technical features of the present disclosure may be combined and replaced with each other without conflict.

The seed dibber 1 provided in the embodiments of the present disclosure is described in detail, and specific examples are used herein to describe principles and the embodiments of the present disclosure, the descriptions of the above embodiments are only used to help understand a method of the present disclosure and a core idea thereof; meanwhile, for those who skilled in the art, according to an idea of the present disclosure, there may be changes in specific embodiments and application ranges, and in summary, a content of the specification should not be construed as limiting the present disclosure.

What is claimed is:

1. A seed dibber, comprising:
a handle; and
at least one dibber tube;
wherein the handle comprises mounting positions disposed along a height direction thereof;
wherein the at least one dibber tube is mounted at any one of the mounting positions disposed along the height direction of the handle for dibbling holes at different depths.

2. The seed dibber according to claim 1, wherein the handle comprises a plurality of groups of the mounting positions, the plurality of the groups of the mounting positions are disposed along a length direction of the handle; and
each of the plurality of the groups of the mounting positions is configured to mount one of the at least one dibber tube, the at least one dibber tube is mounted at at least one of the plurality of the groups of the mounting positions.

3. The seed dibber according to claim 2, wherein the at least one dibber tube is detachably mounted to the handle.

4. The seed dibber according to claim 3, wherein each of the mounting positions comprises a first mounting hole defined on the handle, and the at least one dibber tube defines a second mounting hole; and
the seed dibber further comprises at least one mounting component, the at least one mounting component passes through a corresponding first mounting hole and the second mounting hole and is configured to connect the at least one dibber tube and the handle.

5. The seed dibber according to claim 4, wherein an internal thread is disposed in the second mounting hole, an external thread is disposed on a periphery of the at least one mounting component, and the at least one mounting component is threadedly connected to the internal thread of the second mounting hole through the external thread thereof for connecting the at least one dibber tube and the handle.

6. The seed dibber according to claim 5, wherein the at least one dibber tube comprises an inserting portion and two first connecting portions, the inserting portion and the handle are sequentially disposed in the height direction of the handle, the two first connecting portions are connected to one side of the inserting portion facing the handle, the two first connecting portions are spaced apart from each other and form connecting grooves with the inserting portion; and
the handle is disposed in the connecting grooves and is connected to the two first connecting portions.

7. The seed dibber according to claim 6, wherein a first one of the two first connecting portion defines the second mounting hole, a second one of the two first connecting portion defines a third mounting hole, the at least one mounting component sequentially passes through the third mounting hole, the corresponding first mounting hole, and the second mounting hole, and the at least one mounting component is threadedly connected and fixed to the second mounting hole.

8. The seed dibber according to claim 6, wherein the handle comprises a base plate and limiting portions, each first mounting hole is defined on the base plate, the base plate comprises a first side and a second side, the first side of the base plate is disposed opposite to the second side of the base plate, and each first mounting hole penetrates through the first side of the base plate and the second side of the base plate; and
the limiting portions are disposed on at least one of the first side of the base plate and the second side of the base plate, each two of limiting portions are respectively disposed at two sides of a corresponding first mounting hole along the length direction of the handle, and the two first connecting portions are at least partially disposed between corresponding two of the limiting portions.

9. The seed dibber according to claim 8, wherein each of the limiting portions comprises a first inclined surface at one side thereof facing the inserting portion;
each of the two first connecting portions comprises a middle block and a clamping block, each middle block is connected to the inserting portion, each clamping block is connected to one side of a corresponding middle block facing away from the inserting portion, and each clamping block is configured to be disposed between corresponding two of the limiting portions; and
along the length direction of the handle, a width of each middle block is greater than a width of a corresponding clamping block, the one side of each middle block facing away from the inserting portion comprises a second inclined surface, each second inclined surface is matched with a corresponding first inclined surface.

10. The seed dibber according to claim 8, wherein the at least one mounting component comprises a rod portion and a head portion, and the rod portion passes through the base plate and the two first connecting portion; and
along the length direction of the handle, a width of the head portion is greater than a distance between corresponding two of the limiting portions.

11. The seed dibber according to claim 8, wherein the handle further comprises at least one limiting protrusion, the at least one limiting protrusion is disposed on at least one of the first side of the base plate and the second side of the base plate, along the height direction of the handle, the at least one limiting protrusion is disposed at one side of a corresponding first mounting hole facing the inserting portion; and
at least one of the two first connecting portions defines a limiting groove corresponding to the at least one limiting protrusion, the at least one limiting protrusion is disposed in the limiting groove of the at least one of the two first connecting portions.

12. The seed dibber according to claim 6, wherein the inserting portion is symmetrically disposed along a center line of the two first connecting portions.

13. The seed dibber according to claim 6, wherein the inserting portion comprises an inserting end, the inserting end is distal to the handle, a distance between the inserting end and the handle is inversely related to a cross-sectional area of the inserting end.

14. The seed dibber according to claim 13, wherein the inserting end is conical.

15. The seed dibber according to claim 2, wherein a plurality of dibber tubes are provided, and the plurality of the dibber tubes are uniformly mounted to the handle.

16. The seed dibber according to claim 2, wherein markings are disposed on the handle, and the markings are configured to guide the plurality of the dibber tubes with different quantities to be uniformly mounted on the handle.

17. The seed dibber according to claim 16, wherein the markings are grouped and evenly spaced along the handle, different groups of the markings are labeled with different numerals, and the different numerals are configured to guide corresponding quantities of the plurality of the dibber tubes to be uniformly mounted on the handle.

18. The seed dibber according to claim 1, wherein the handle comprises a base plate and a grip, the at least one dibber tube is mounted to a first side of the base plate, the grip protrudes from a second side of the base plate for a human hand to hold.

19. The seed dibber according to claim 18, wherein the grip comprises a holding portion and two second connecting portions, the holding portion is spaced apart from the base plate, two ends of the holding portion are connected to the base plate respectively through the two second connecting portions.

20. The seed dibber according to claim 19, wherein the holding portion comprises a hollow tubular body, two ends of the hollow tubular body are connected to the base plate respectively through the two second connecting portions, and an outer surface of the hollow tubular body is an arc surface.
